(19) United States
(12) Patent Application Publication
(10) Pub. No.: US 2023/0117336 A1
(43) Pub. Date: Apr. 20, 2023

(54) LIQUID DISCHARGE DEVICE AND LIQUID DISCHARGE APPARATUS

(71) Applicants: Tatsuya Suzuki, Kanagawa (JP); Yasuyuki Horie, Kanagawa (JP)

(72) Inventors: Tatsuya Suzuki, Kanagawa (JP); Yasuyuki Horie, Kanagawa (JP)

(73) Assignee: Ricoh Company, Ltd., Tokyo (JP)

(21) Appl. No.: 17/965,771

(22) Filed: Oct. 14, 2022

(30) Foreign Application Priority Data
Oct. 18, 2021 (JP) 2021-170220

(51) Int. Cl. B41J 2/045

(52) U.S. Cl. CPC B41J 2/04581; B41J 2/04588; B41J 2/04541

(57) ABSTRACT

A liquid discharge device includes: a piezoelectric element to which a drive voltage is applied; a nozzle from which a liquid is to be discharged in accordance with a change of the drive voltage; and circuitry configured to: generate: a first drive waveform including first multiple pulses switchable at first switch timings; and a second drive waveform including second multiple pulses different from the first multiple pulses switchable at second switch timings, at least one the first switch timings of the first multiple pulses of the first drive waveform and at least one of the second switch timings of the second multiple pulses of the second drive waveform are the same; select first selected pulses from the first multiple pulses in the first drive waveform; and select second selected pulses from the second multiple pulses in the second drive waveform.

### CROSS-REFERENCE TO RELATED APPLICATIONS

This patent application is based on and claims priority pursuant to 35 U.S.C. § 119(a) to Japanese Patent Application No. 2021-170220, filed on Oct. 18, 2021, in the Japan Patent Office, the entire disclosure of which is hereby incorporated by reference herein.

### BACKGROUND

### Technical Field

The present disclosure relates to a liquid discharge device and a liquid discharge apparatus.

### Related Art

A liquid discharge device mounted on an inkjet recording apparatus is used as an image forming apparatus, such as a printer, a facsimile, a multifunction peripheral, or a plotter. The liquid discharge device modulates, based on a drive waveform, a volume of an ink droplet to be discharged from a recording head, to represent gradation corresponding to the value of a pixel in an image. This type of liquid discharge device selects any pulse from multiple pulses in each of multiple drive waveforms and combines the selected pulses to generate a drive voltage to be applied to a recording head.

### SUMMARY

A liquid discharge device includes: a piezoelectric element to which a drive voltage is applied; a nozzle from which a liquid is to be discharged in accordance with a change of the drive voltage; and circuitry configured to: generate: a first drive waveform including first multiple pulses switchable at first switch timings; and a second drive waveform including second multiple pulses different from the first multiple pulses switchable at second switch timings, at least one the first switch timings of the first multiple pulses of the first drive waveform and at least one of the second switch timings of the second multiple pulses of the second drive waveform are the same; select first selected pulses from the first multiple pulses in the first drive waveform; and select second selected pulses from the second multiple pulses in the second drive waveform, and the second selected pulses do not overlap with the first selected pulses; couple the first selected pulses and the second selected pulses to generate the drive voltage.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram of an image forming apparatus equipped with a liquid discharge device according to a first embodiment of the present disclosure;

FIG. 2 is a plan view of an exemplary configuration of a liquid discharge unit in FIG. 1;

FIG. 3 is a plan view of an exemplary conveyance drum in FIG. 1;

FIG. 4 is a block diagram of an exemplary hardware configuration of a liquid discharge head in FIG. 2 and a head drive circuit board connected to the liquid discharge head;

FIG. 5 is a cross-sectional view of an exemplary structure of the liquid discharge head in FIG. 4;

FIGS. 6A and 6B are explanatory timing charts of an exemplary operation of the liquid discharge device in FIG. 1;

FIGS. 7A and 7B are explanatory timing charts of an exemplary operation of a liquid discharge device of a comparative example;

FIGS. 8A and 8B are explanatory timing charts of an exemplary operation of a liquid discharge device according to a second embodiment;

FIGS. 9A and 9B are explanatory timing charts of an exemplary operation of a liquid discharge device according to a third embodiment; and

FIGS. 10A and 10B are explanatory timing charts of an exemplary operation of a liquid discharge device according to a fourth embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments will be described below with reference to the drawings. Note that the same constituent elements in the drawings are denoted with the same reference signs, and thus the duplicate descriptions of the same constituent elements will be appropriately omitted.

A liquid discharge device serving as a device that discharges liquid includes a liquid discharge head or a liquid discharge unit and drives the liquid discharge head to discharge liquid. Examples of such a device that discharges liquid include a device capable of discharging liquid to an object to which liquid can adhere and a device that discharges liquid into gas or liquid. Examples of an apparatus equipped with such a liquid discharge device include an image forming apparatus, a solid shaping apparatus, a treatment-liquid coating apparatus, and a jet granulation apparatus.

A liquid discharge device can also include means of feeding, conveying, or ejecting an object to which liquid can adhere, a preprocessing apparatus, and a postprocessing apparatus.

Examples of an apparatus equipped with a liquid discharge device include an image forming apparatus that discharges ink to a sheet of paper to form an image on the sheet of paper and a solid shaping apparatus (three-dimensionally shaping apparatus) that discharges shaping liquid to a powder-conglomeration layer as a layered conglomeration of powder in order to shape a solid shaped object (three-dimensionally shaped object).

A liquid discharge device is not necessarily an apparatus that visualizes a meaningful image, such as a character or a figure, with discharged liquid. For example, a liquid discharge device may be an apparatus that forms an arbitrary pattern or an apparatus that fabricates a three-dimensional object.

The “object to which liquid can adhere” denotes an object to which liquid can adhere at least temporarily, an object on which liquid fastens after adhering to, and an object into which liquid permeates after adhering to. Specific examples of the “object to which liquid can adhere” include a recording medium, such as a sheet of paper, recording paper, a sheet of recording paper, a film, or cloth, an electronic component, such as an electronic circuit board or a piezoelectric element, and a medium, such as a powder-conglomeration layer (powder layer), an organ model, or a testing cell. Unless otherwise particularly limited, the “object to which liquid can adhere” may be any object to which liquid adheres.

Examples of the material of the “object to which liquid can adhere” include paper, thread, fiber, fabric, leather, metal, plastic, glass, wood, and ceramic that enable temporal adhesion of liquid.

The “liquid” may be any liquid of which the viscosity or surface tension enables discharge from a head. The “liquid” has preferably, but is not particularly limited to, a viscosity of 30 mPa·s or less at room temperature and atmospheric pressure or after heating or cooling. More specific examples of the “liquid” include a solution, a suspension, and an emulsion that contain a solvent, such as water or an organic solvent, a colorant, such as dye or pigment, a functional material, such as a polymerizable compound, resin, or a surfactant, a biocompatible material, such as deoxyribonucleic acid (DNA), an amino acid, protein, or calcium, or an edible material, such as a natural pigment. Such liquids can be used, for example, for inkjet inks, surface treatment liquids, liquids for formation of resist patterns of constituent elements of electronic elements and light-emitting elements or for formation of resist patterns of electronic circuits, and material liquids for three-dimensional shaping.

A liquid discharge device achieves relative movement between a liquid discharge head and an object to which liquid can be adhere, but this is not limiting. Specific examples of liquid discharge devices include a serial type device that moves a liquid discharge head and a line type device that does not move a liquid discharge head.

In addition, examples of an apparatus equipped with a liquid discharge device include a treatment-liquid coating apparatus that discharges, for the purpose of reforming the surface of a sheet of paper, treatment liquid to the sheet of paper to coat the treatment liquid on the surface of the sheet of paper, and a jet granulation apparatus that jets a composition liquid including row material dispersed in a solution, through a nozzle to granulate fine particles of the row material.

Below described will be exemplary embodiments in which a liquid discharge device is mounted on a line scanning inkjet image forming apparatus with the “object to which liquid can adhere” as a sheet.

Liquid Discharge Device According to First Embodiment

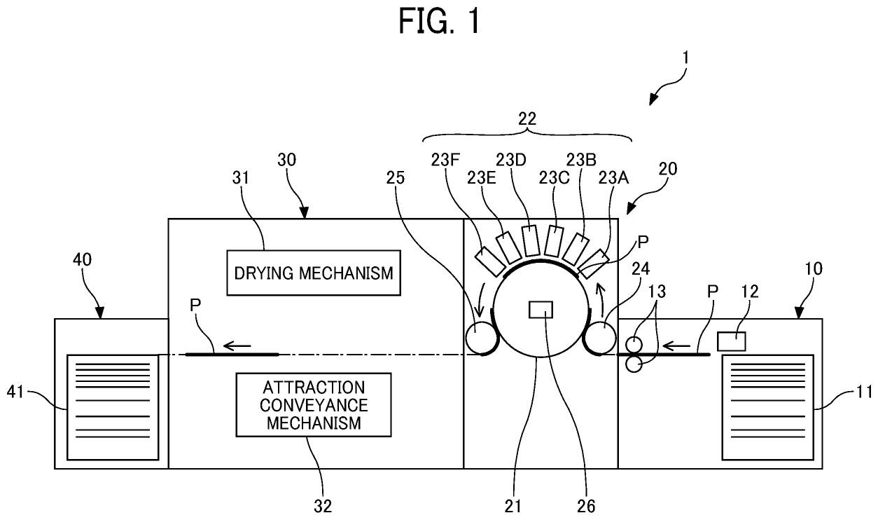

FIG. 1 is a block diagram of an image forming apparatus equipped with a liquid discharge device according to a first embodiment of the present disclosure. An image forming apparatus 1 illustrated in FIG. 1 includes an import unit 10, an image forming unit 20, a drying unit 30, and an export unit 40. In the image forming apparatus 1, the image forming unit 20 gives liquid to a sheet P as a sheet member imported from the import unit 10, to perform desired image forming. The drying unit 30 dries the liquid having adhered to the sheet P, and then the sheet P is discharged to the export unit 40.

The image forming apparatus 1 is an example of a liquid discharge apparatus.

The import unit 10 includes an import tray 11 into which multiple sheets P is loaded, a feeding device 12 that separates a single sheet P from the multiple sheets P in the import tray 11 and sends out the sheet P, and a pair of registration rollers 13 that sends the sheet P to the image forming unit 20.

As the feeding device 12, a feeding device including a roller or a rolling member or a feeding device with air suction can be used. After the leading end of the sheet P sent out from the import tray 11 by the feeding device 12 arrives at the pair of registration rollers 13, the pair of registration rollers 13 drives at a predetermined timing to send the sheet P to the image forming unit 20.

The image forming unit 20 includes a conveyance drum 21 that is an exemplary rotating member as a conveyor that conveys a sheet P while bearing the sheet P on its outer circumferential face, and a liquid discharge device 22 that discharges liquid to the sheet P borne on the conveyance drum 21.

The image forming unit 20 includes a transfer barrel 24 that receives the sent sheet P and transfers the sheet P to the conveyance drum 21, and a transfer barrel 25 that transfers the sheet P conveyed by the conveyance drum 21 to the drying unit 30.

The leading end of the sheet P conveyed from the import unit 10 to the image forming unit 20 is gripped by a sheet gripper on the surface of the transfer barrel 24 and then the sheet P is conveyed along with rotation of the transfer barrel 24. The sheet P conveyed by the transfer barrel 24 is transferred to the conveyance drum 21 at the opposed position to the conveyance drum 21.

Because the surface of the conveyance drum 21 is provided with a sheet gripper, the leading end of the sheet P is gripped by the sheet gripper. The conveyance drum 21 has multiple suction holes dispersed on its surface. A suction device 26 as a sucker generates an air suction current inward from the suction holes of the conveyance drum 21.

Then, the sheet P transferred from the transfer barrel 24 to the conveyance drum 21 is conveyed along with rotation of the conveyance drum 21 while being attracted on the conveyance drum 21 due to the air suction current by the suction device 26 with the leading end of the sheet P gripped by the sheet gripper.

The liquid discharge device 22 includes multiple liquid discharge units 23 (23A to 23F). For example, the liquid discharge units 23A, 23B, 23C, and 23D discharge, respectively, cyan (C) liquid, magenta (M) liquid, yellow (Y) liquid, and black (K) liquid. The liquid discharge units 23E and 23F are each used to discharge any of Y liquid, M liquid, C liquid, and K liquid, or special liquid, such as white liquid, gold liquid, or silver liquid. Furthermore, the liquid discharge device 22 can be provided with a discharge unit that discharges treatment liquid, such as surface coating liquid. The liquid discharge units 23 are each controlled in discharge operation, based on a drive signal corresponding to print information. When the sheet P borne on the conveyance drum 21 passes through the opposed region to the liquid discharge device 22, the liquid discharge units 23 discharge the respective color liquids, so that an image corresponding to image data is formed on the sheet P.

The drying unit 30 includes a drying mechanism 31 that dries the liquid having adhered on the sheet P due to the image forming unit 20, and an attraction conveyance mechanism 32 that conveys the sheet P conveyed from the image forming unit 20 while attracting the sheet P.

After the attraction conveyance mechanism 32 receives the sheet P conveyed from the image forming unit 20, the sheet P is conveyed while passing the drying mechanism 31, so that the export unit 40 receives the sheet P. When the sheet P passes the drying mechanism 31, the liquid on the sheet P is subjected to drying. Thus, a liquid component, such as moisture, in the liquid evaporates, so that the colorant contained in the liquid is fixed on the sheet P. Additionally, the sheet P is inhibited from curling.

The export unit 40 includes an export tray 41 into which multiple sheets P is loaded. The sheet P conveyed from the drying unit 30 is in order stacked and retained on the export tray 41. Note that the image forming apparatus 1 may include a preprocessing unit that is disposed upstream of the image forming unit 20 and performs preprocessing to a sheet P and may include a postprocessing unit that is disposed between the drying unit 30 and the export unit 40 and performs postprocessing to a sheet P.

For example, the preprocessing unit may perform pre-coating to coat a sheet P with treatment liquid that reacts with liquid to inhibit bleeding. The postprocessing unit may perform, for printing on both sides of a sheet P, sheet inversion conveyance processing to invert the printed sheet from the image forming unit 20 and send the inverted sheet to the image forming unit 20 or may perform processing to bind multiple sheets.

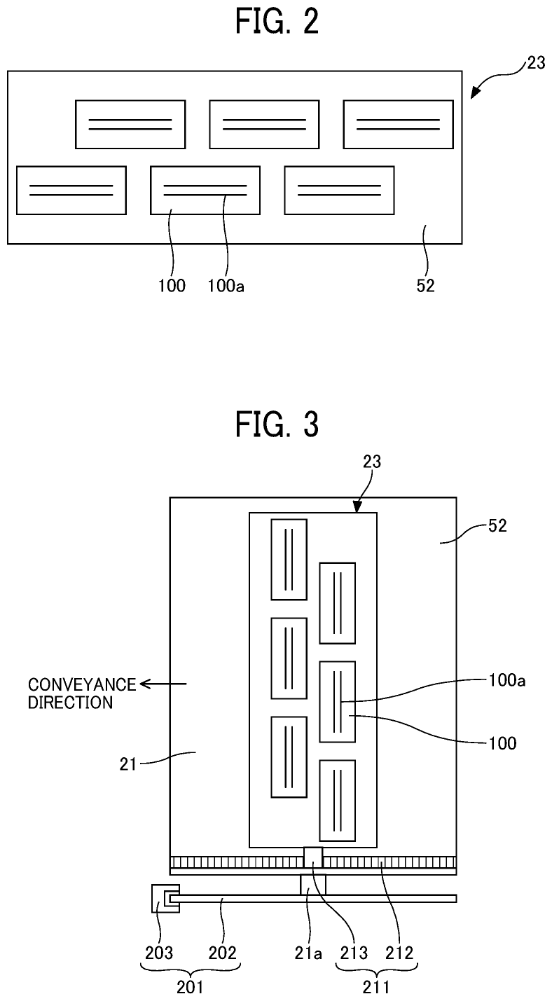

FIG. 2 is a plan view of an exemplary configuration of a liquid discharge unit 23 in FIG. 1. The liquid discharge unit 23 is, for example, a full-line type head and includes multiple liquid discharge heads 100 disposed on a base member 52, in which each liquid discharge head 100 includes a nozzle array 100a in which multiple nozzles is arrayed. Note that the configuration of the liquid discharge unit 23 in FIG. 2 is not limiting.

FIG. 3 is a plan view of an example of the conveyance drum 21 in FIG. 1. Note that, for easy understanding of description, FIG. 3 illustrates a single liquid discharge unit 23 having an enlarged width in a conveyance direction.

The conveyance drum 21 has a rotary shaft 21a provided with an encoder wheel 202. An encoder sensor 203 that reads the encoder wheel 202 is disposed at the outer circumferential portion of the encoder wheel 202. Then, the encoder wheel 202 and the encoder sensor 203 are constituent elements of a first encoder 201. The first encoder 201 serves as a rotary encoder and outputs a first signal (output pulse) corresponding to the amount of rotation of the conveyance drum 21 (amount of drive in rotation).

The conveyance drum 21 has a circumferential face provided with an encoder scale 212. An encoder sensor 213 that reads the encoder scale 212 is disposed opposite the encoder scale 212. Then, the encoder scale 212 and the encoder sensor 213 are constituent elements of a second encoder 211. The second encoder 211 serves as a linear encoder and outputs a second signal (output pulse) corresponding to the amount of movement of the circumferential face of the conveyance drum 21. The second signal includes information correlating with the amount of movement of a sheet P on the circumferential face of the conveyance drum 21.

The encoder sensor 213 in the second encoder 211 is disposed near each of the multiple liquid discharge units 23. In the example of FIG. 3, the encoder sensor 213 is attached to the base member 52 on which the liquid discharge unit 23 is disposed. Therefore, the encoder sensor 213 attached to the base member 52 of each liquid discharge unit 23 and the encoder scale 212 provided on the conveyance drum 21 are constituent elements of the second encoder 211 for the corresponding liquid discharge unit 23.

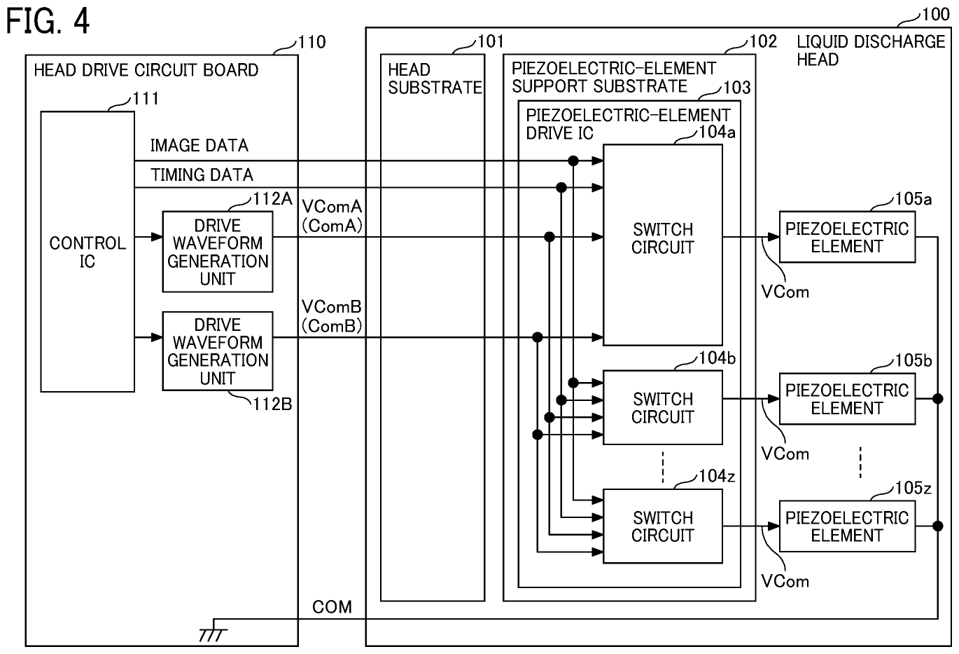

FIG. 4 is a block diagram of an exemplary hardware configuration of a liquid discharge head 100 in FIG. 2 and a head drive circuit board 110 connected to the liquid discharge head 100. That is, FIG. 4 illustrates an exemplary main part of the liquid discharge device 22 in FIG. 1.

The head drive circuit board 110 includes a control integrated circuit (IC) 111 and drive waveform generators 112A and 112B that each generate a drive waveform corresponding to a type of droplet. The control IC 111 outputs, to the liquid discharge head 100, image data for use in selection of a type of droplet and timing data including multiple switch patterns indicating on/off of a switch circuit 104 and outputs drive timing to the drive waveform generators 112A and 112B. The head drive circuit board 110 may also be referred to as “circuitry”.

Based on the drive timing from the control IC 111, the drive waveform generator 112A outputs, to the liquid discharge head 100, a drive voltage VComA having a common drive waveform ComA including multiple pulses. Based on the drive timing from the control IC 111, the drive waveform generator 112B outputs, to the liquid discharge head 100, a drive voltage VComB having a common drive waveform ComB including multiple pulses.

That is, the head drive circuit board 110 can generate two types of drive waveforms ComA and ComB. Note that the head drive circuit board 110 may generate three or more types of drive waveforms Com with three or more drive waveform generators. The drive waveform generators 112A and 112B may be integrally formed.

The liquid discharge head 100 includes a head substrate 101, a piezoelectric-element support substrate 102, and multiple piezoelectric elements 105 (105a, 105b to 105z). A piezoelectric-element drive IC 103 including switch circuits 104 (104a, 104b to 104z) corresponding one-to-one to the piezoelectric elements 105 is mounted on the piezoelectric-element support substrate 102. The switch circuits 104 are each an exemplary drive controller that generates a drive voltage.

For each of the drive waveforms ComA and ComB, each switch circuit 104 selects, from the timing data, a switch pattern corresponding to gradation based on the value of a pixel for use in generation of a droplet in the image data received from the head drive circuit board 110. For example, the timing data includes data of the multiple switch patterns. Each switch circuit 104 selects, in accordance with each selected switch pattern, a pulse from the corresponding drive waveform ComA or ComB, and combines (couples) the selected pulses to generate a drive voltage. Then, each switch circuit 104 supplies the generated drive voltage to the piezoelectric element 105. Note that a pulse to be selected by each switch circuit 104 may include a minute vibration pulse not for discharging an ink droplet between pulses for discharging an ink droplet. Such a minute vibration pulse is used in order to minutely vibrate the meniscus face of a nozzle hole to prevent drying.

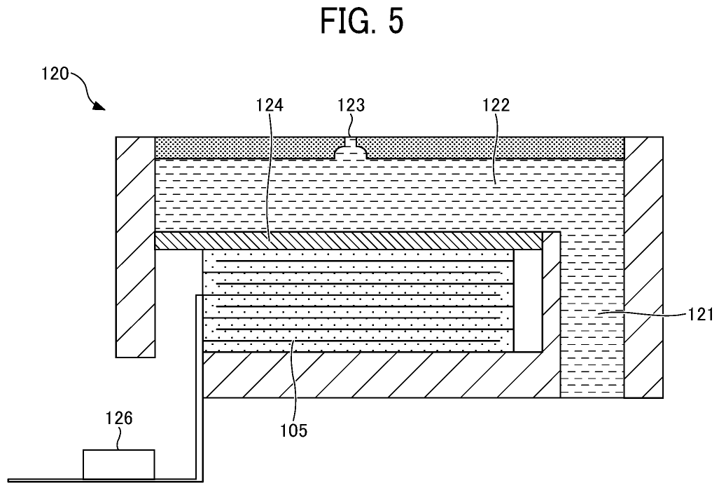

Each piezoelectric element 105 discharges, based on the drive voltage output from the switch circuit 104, ink droplets different in size through a nozzle 123 (see FIG. 5) per print cycle T. Each piezoelectric element 105 vibrates, based on the drive voltage corresponding to the minute vibration pulse not for discharging an ink droplet, the meniscus face of the nozzle hole, minutely.

FIG. 5 is a cross-sectional view of an exemplary structure of the liquid discharge head 100 in FIG. 4. FIG. 5 illustrates an exemplary structure of a discharge block 120 corresponding to one of the nozzles in the nozzle array 100a of FIG. 2 in the liquid discharge head 100.

The discharge block 120 includes a pressurization liquid chamber 122 in which ink 121 flows, a nozzle 123, and a diaphragm 124, in which the nozzle 123 and the diaphragm 124 are opposite through the pressurization liquid chamber 122. The diaphragm 124 is in contact with a wall face of the pressurization liquid chamber 122. The discharge block 120 includes a piezoelectric element 105 in contact with the diaphragm 124 and a driver IC 126 electrically connected to the piezoelectric element 105. For example, the driver IC 126 is mounted in the corresponding switch circuit 104 in FIG. 4.

In accordance with the drive voltage applied from the driver IC 126, the piezoelectric element 105 deforms to change the volume of the pressurization liquid chamber 122 through the diaphragm 124, so that the pressure of the ink 121 is changed in the pressurization liquid chamber 122. In response to pressurization to the ink 121 in the pressurization liquid chamber 122, the pressurized ink 121 is discharged as a liquid droplet through the nozzle 123. The amount of a liquid droplet to be discharged can be adjusted by the pressure applied to the ink 121 in accordance with the drive voltage.

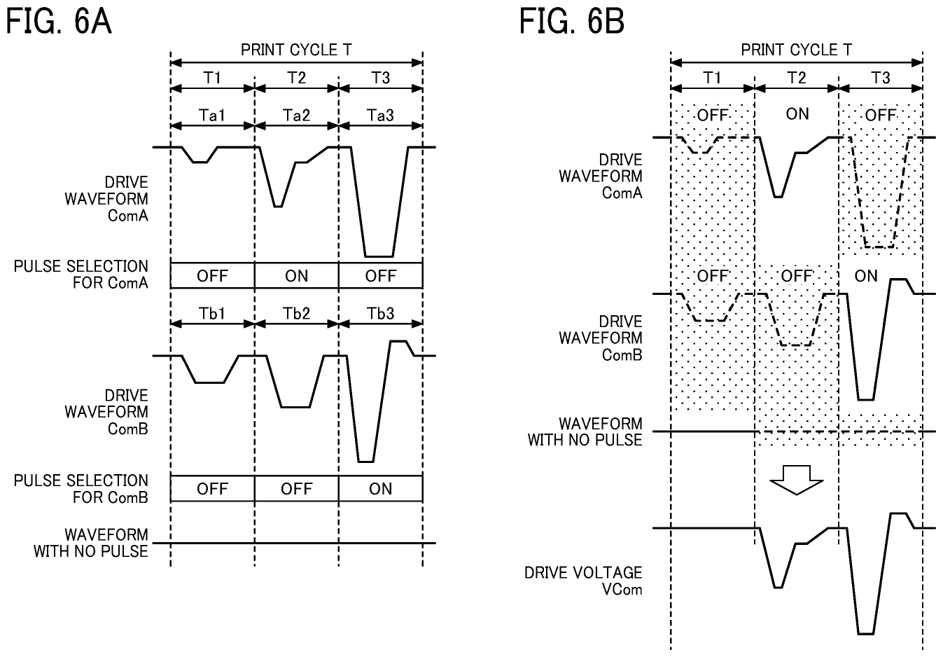

FIGS. 6A and 6B are explanatory timing charts of an exemplary operation of the liquid discharge device 22 in FIG. 1.

FIG. 6A illustrates exemplary driving of one of the piezoelectric elements 105 in the liquid discharge head 100 illustrated in FIG. 4. The drive waveform ComA is a common waveform to be periodically supplied to all the switch circuits 104 in the liquid discharge head 100 from the drive waveform generator 112A in FIG. 4. Similarly, the drive waveform ComB is a common waveform to be periodically supplied to all the switch circuits 104 in the liquid discharge head 100 from the drive waveform generator 112B. Note that the drive waveform ComA indicates the drive voltage VComA, and the drive waveform ComB indicates the drive voltage VComB.

In the example of FIG. 6A, during the print cycle T, the drive waveforms ComA and ComB each have three pulses to be switched. The switch timing between the pulses of the drive waveform ComA and the switch timing between the pulses of the drive waveform ComB are set mutually the same. Thus, the pulse cycle Ta1 of the drive waveform ComA and the pulse cycle Tb1 of the drive waveform ComB are mutually identical (=pulse cycle T1).

The pulse cycle Ta2 of the drive waveform ComA and the pulse cycle Tb2 of the drive waveform ComB are mutually identical (=pulse cycle T2). The pulse cycle Ta3 of the drive waveform ComA and the pulse cycle Tb3 of the drive waveform ComB are mutually identical (=pulse cycle T3). The waveform profiles of the pulses of the drive waveforms ComA and ComB are mutually different.

Difference between the waveform profiles of the pulses enables an increase in the number of combinations of pulses. Combinations of pulses enable an increase in the number of representable gradations. Note that the number of pulse cycles in the print cycle T is not limited to three and thus can be increased as far as possible in the print cycle.

For generation of a drive voltage VCom to be practically applied to each piezoelectric element 105 in the liquid discharge head 100, either of the pulses of the drive waveforms ComA and ComB in each of the pulse cycles T1, T2, and T3 is selected and then the selected pulses are combined (coupled) together. Note that, in each of the pulse cycles T1, T2, and T3, neither of the pulses of the drive waveforms ComA and ComB may be selected. In this case, a waveform with no pulse is applied to the piezoelectric elements 105. The value (fixed value) of such a waveform with no pulse is identical to the initial values (values at the time of no pulse) of the drive waveforms ComA and ComB.

Referring to FIG. 6B, in each of the pulse cycles T1, T2, and T3, the notation “ON” indicates selection of a pulse and the notation “OFF” indicates non-selection of a pulse. In each shaded OFF period, no pulse is selected. Each dashed waveform indicates that no pulse is selected.

For example, for each of the drive waveforms ComA and ComB, each switch circuit 104 selects, from the timing data, a switch pattern for selection of a type of droplet corresponding to the value of the corresponding pixel in the image data supplied from the control IC 111. Then, each switch circuit 104 combines the pulses of the drive waveforms ComA and ComB selected in accordance with the selected timing data, to generate a drive voltage VCom. Then, each switch circuit 104 applies the generated drive voltage VCom to the corresponding piezoelectric element 105.

Each piezoelectric element 105 discharges a liquid droplet of which the discharge amount corresponds to the drive voltage VCom received from the corresponding switch circuit 104. Note that, in the pulse cycle (T1, T2, or T3) in which neither of the pulses of the drive waveforms ComA and ComB is selected, each switch circuit 104 supplies the piezoelectric element 105 with a voltage corresponding to a waveform with no pulse.

In the present embodiment, the pulse cycles Ta1, Ta2, and Ta3 of the drive waveform ComA are identical, respectively, to the pulse cycles Tb1, Tb2, and Tb3 of the drive waveform ComB, with coincidence in generation timing. This leads to coincidence between the switch timing between the pulses of the drive waveform ComA and the switch timing between the pulses of the drive waveform ComB. As a result, even in a case where either of the pulses of the drive waveforms ComA and ComB is selected in each of the pulse cycles T1, T2, and T3, any pulse of the drive waveform ComA and any pulse of the drive waveform ComB can be prevented from overlapping.

In each of the pulse cycles T1, T2, and T3, either the pulse of the drive waveform ComA or the pulse of the drive waveform ComB can be selected. Therefore, the number of representable gradations can be increased with preventing a reduction in the number of combinations of selections of pulses for use in generation of a drive voltage VCom. For example, in a case where the numbers of pulses of the drive waveforms ComA and ComB in the print cycle T are each defined as “n”, ideally, 3ⁿ number of gradations can be represented. Thus, referring to FIGS. 6A and 6B with n being three (3), ideally, 27 number of gradations can be represented.

Note that each switch circuit 104 may exclude at least the pulses in the top pulse cycles Ta1 and Tb1 or the pulses in the last pulse cycles Ta3 and Tb3 in the drive waveforms ComA and ComB, from pulses for use in generation of a drive voltage VCom. In this case, based on the period corresponding to the excluded pulses, the generation period of a drive voltage VCom can be changed (shortened). Thus, the drive frequency of each piezoelectric element 105 is higher in that case than in a case where no pulses are excluded. A higher drive frequency enables a shorter print cycle T, so that an increase can be made in the number of pixels printable per unit of time.

Selection of one of the pulses of the drive waveforms ComA and ComB as a minute vibration pulse enables inhibition of the liquid surface at the opening of the nozzle 123 from drying.

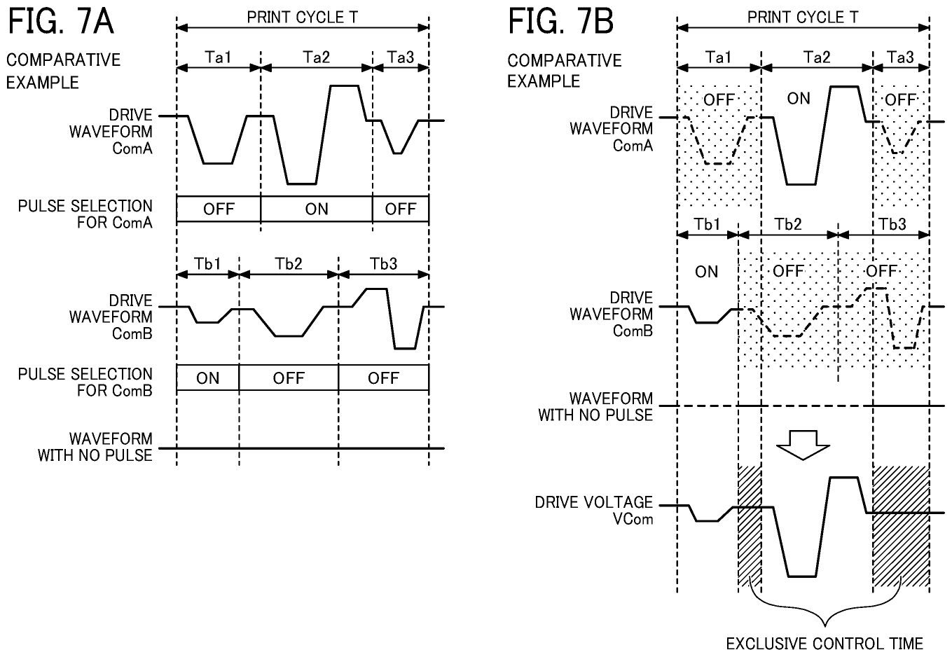

FIGS. 7A and 7B are explanatory timing charts of an exemplary operation of a liquid discharge device of comparative example. Operations similar to the operations in FIGS. 6A and 6B are denoted with the same reference signs and the detailed descriptions of the operations will be omitted.

In the liquid discharge device that operates as illustrated in FIG. 7A, the pulse cycle Tb1 is shorter than the pulse cycle Ta1. In addition, the pulse cycle Tb2 is shorter than the pulse cycle Ta2, and the pulse cycle Tb3 is longer than the pulse cycle Ta3. Thus, the drive waveform ComA and the drive waveform ComB are different in terms of the switch timing between pulses.

In the example of FIG. 7B, the pulse in the pulse cycle Ta2 of the drive waveform ComA is selected and the pulse in the pulse cycle Tb1 of the drive waveform ComB is selected. The pulse cycle Tb3 of the drive waveform ComB includes a period overlapping the pulse cycle Ta2 of the drive waveform ComA. For prevention of failure due to a short circuit between driver ICs 126, selection of the pulse cycle Tb3 is not allowed.

As a result, referring to FIG. 7B, the striped periods of the waveform of the drive voltage VCom occur, namely, exclusive control time, in which neither of the pulses of the drive waveforms ComA and ComB is selected, occurs. In a case where the drive waveforms ComA and ComB that causes such exclusive control time to occur are set, a reduction is made in the number of representable gradations. In other words, in a case where the drive waveforms ComA and ComB are different in terms of the switch timing between pulses and a pulse cycle of one of the drive waveforms overlaps two pulse cycles of the other drive waveform, a reduction is made in the number of representable gradations.

In the first embodiment as described above in FIGS. 6A and 6B, the drive waveforms ComA and ComB are set mutually the same in terms of the cycle of a pulse overlapping in timing and the generation timing of a pulse, leading to coincidence in the switch timing between pulses. Thus, in each of the pulse cycles T1, T2, and T3, selection of either of the pulses of the drive waveforms ComA and ComB enables generation of a drive voltage VCom. As a result, such exclusive control time as illustrated in FIGS. 7A and 7B can be prevented from occurring. Thus, the discharge amount of a liquid droplet can be controlled more minutely, so that an increase can be made in the number of representable gradations.

Mutual difference between the waveform profiles of the pulses of the drive waveforms ComA and ComB enables an increase in the number of combinations of pulses, so that an increase can be made in the number of representable gradations based on combinations of pulses.

Exclusion of at least the pulses in the pulse cycles Ta1 and Tb1 or the pulses in the pulse cycles Ta3 and Tb3 in the drive waveforms ComA and ComB from pulses for use in generation of a drive voltage VCom enables a higher drive frequency of the piezoelectric element 105. This leads to a shorter print cycle T, so that an increase can be made in the number of pixels printable per unit of time.

Liquid Discharge Device According to Second Embodiment

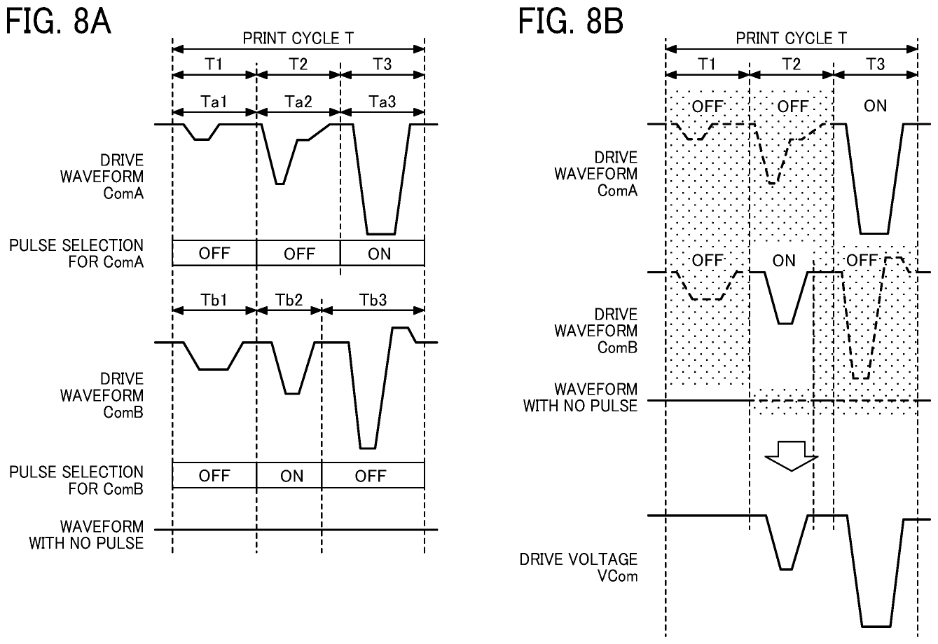

FIGS. 8A and 8B are explanatory timing charts of an exemplary operation of a liquid discharge device according to a second embodiment. The detailed descriptions of operations similar to the operations in FIGS. 6A and 6B are omitted.

The configuration and function of the liquid discharge device that implements the operation in FIGS. 8A and 8B are similar to the configuration and function of the liquid discharge device 22 illustrated in FIG. 1, except for difference in terms of drive waveforms ComA and ComB. The liquid discharge device 22 according to the present embodiment is mounted, for example, on the image forming apparatus 1 illustrated in FIG. 1. For example, the configuration of the liquid discharge device according to the present embodiment is similar to the configuration described with FIGS. 2 to 5. Thus, in the following description, used are such constituents with reference signs as described with FIGS. 2 to 5.

In the present embodiment, similarly to FIGS. 6A and 6B, the pulse cycles Ta1 and Tb1 of the drive waveforms ComA and ComB are mutually identical with coincidence in the generation timing of a pulse. Meanwhile, the pulse cycles Ta2 and Tb2 of the drive waveforms ComA and ComB are mutually different with difference in the termination timing of a pulse. The pulse cycles Ta3 and Tb3 of the drive waveforms ComA and ComB are mutually different with difference in the start timing of a pulse. The waveform profiles of the pulses of the drive waveforms ComA and ComB are mutually different.

The pulse cycle Ta2 of the drive waveform ComA overlaps at least part of the pulse cycles Tb2 and Tb3 of the drive waveform ComB. The pulse cycle Tb3 of the drive waveform ComB overlaps at least part of the pulse cycles Ta2 and Ta3 of the drive waveform ComA. Thus, in a case where pulses are selected with the pulse cycle Ta2 and the pulse cycle Tb3 illustrated in FIG. 8 set ON, the pulses interfere mutually, so that a short circuit occurs between driver ICs 126. That is, the drive pattern illustrated in FIG. 8 is a pattern unusable in practice. In order to inhibit a short circuit between driver ICs 126, a switch circuit 104 selects pulses such that the pulses do not overlap mutually between the drive waveforms ComA and ComB, and generates a drive voltage VCom having a shape in which the selected pulses are coupled.

However, since the pulse cycles Ta1 and Tb1 are mutually identical with coincidence in the generation timing of a pulse, an increase can be made in the number of representable gradations in comparison to FIGS. 7A and 7B. For example, in a case where the numbers of pulses of the drive waveforms ComA and ComB in the print cycle T are each defined as n, ideally, (3ⁿ−3) number of gradations can be represented. Thus, referring to FIGS. 8A and 8B with n being three (3), ideally, 24 number of gradations can be represented.

As described above, the present embodiment enables acquisition of an effect similar to the effect of each embodiment described above. For example, coincidence between the pulse cycles Ta1 and Tb1 with coincidence in the generation timing of a pulse enables an increase in the number of representable gradations in comparison to FIGS. 7A and 7B.

Liquid Discharge Device According to Third Embodiment

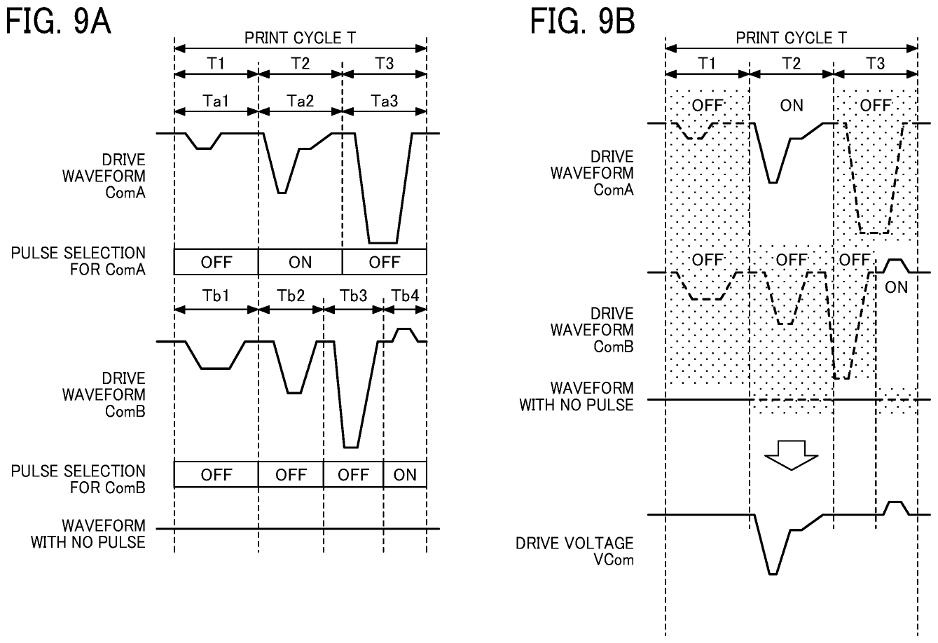

FIGS. 9A and 9B are explanatory timing charts of an exemplary operation of a liquid discharge device according to a third embodiment. The detailed descriptions of operations similar to the operations in FIGS. 6A and 6B to FIGS. 8A and 8B are omitted. The configuration and function of the liquid discharge device that implements the operation in FIGS. 9A and 9B are similar to the configuration and function of the liquid discharge device 22 illustrated in FIG. 1, except for difference in terms of drive waveforms ComA and ComB.

The liquid discharge device 22 according to the present embodiment is mounted, for example, on the image forming apparatus 1 illustrated in FIG. 1. For example, the configuration of the liquid discharge device according to the present embodiment is similar to the configuration described with FIGS. 2 to 5. Thus, in the following description, used are such constituents with reference signs as described with FIGS. 2 to 5.

In the present embodiment, similarly to FIGS. 6A and 6B, the pulse cycles Ta1 and Tb1 of the drive waveforms ComA and ComB are mutually identical with coincidence in the generation timing of a pulse. The pulse cycles Ta2 and Ta3 of the drive waveform ComA are identical to the pulse cycles Ta2 and Ta3 in FIG. 6A. Meanwhile, the drive waveform ComB has four pulse cycles Tb1, Tb2, Tb3, and Tb4. In other words, the drive waveform ComB has three pulse cycles Tb2, Tb3, and Tb4 in the period of the pulse cycles Ta2 and Ta3 of the drive waveform ComA.

The number of pulses in the drive waveform ComB larger than the number of pulses in the drive waveform ComA enables an increase in the number of combinations of pulses of the drive waveforms ComA and ComB. As a result, an increase can be made in the number of representable gradations. As described above, the present embodiment enables acquisition of an effect similar to the effect of each embodiment described above.

[Liquid Discharge Device According to Fourth Embodiment]

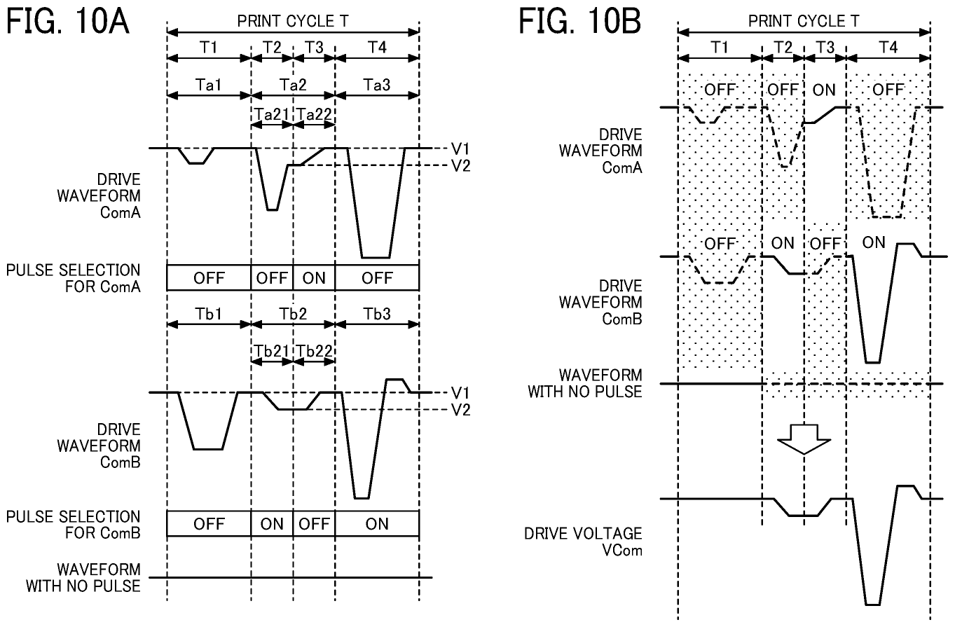

FIGS. 10A and 10B are explanatory timing charts of an exemplary operation of a liquid discharge device according to a fourth embodiment. The detailed descriptions of operations similar to the operations in FIGS. 6A and 6B to FIGS. 9A and 9B are omitted. The configuration and function of the liquid discharge device that implements the operation in FIGS. 10A and 10B are similar to the configuration and function of the liquid discharge device 22 illustrated in FIG. 1, except for difference in terms of drive waveforms ComA and ComB.

The liquid discharge device 22 according to the present embodiment is mounted, for example, on the image forming apparatus 1 illustrated in FIG. 1. For example, the configuration of the liquid discharge device according to the present embodiment is similar to the configuration described with FIGS. 2 to 5. Thus, in the following description, used are such constituents with reference signs as described with FIGS. 2 to 5.

In the present embodiment, the print cycle T includes four pulse cycles T1, T2, T3, and T4. The pulse cycles Ta2 and Tb2 of the drive waveforms ComA and ComB are each included in the pulse cycles T2 and T3. Two pulses in each of the pulse cycles Ta2 and Tb2 can be set as selection (ON) or non-selection (OFF) in each of the pulse cycles T2 and T3. In other words, the two pulses in each of the pulse cycles Ta2 and Tb2 can be selected or non-selected in each of the former half (T2) and the latter half (T3). Thus, the number of representable gradations can be further increased.

The pulse cycle Ta2 includes a pulse cycle Ta21 including a pulse and a pulse cycle Ta22 including a pulse. The pulse cycle Tb2 includes a pulse cycle Tb21 including a pulse and a pulse cycle Tb22 including a pulse. The values at the boundary of the pulse in the pulse cycle Ta21 and the pulse in the pulse cycle Ta22 that are adjacent mutually are both set at V2. The values at the boundary of the pulse in the pulse cycle Tb21 and the pulse in the pulse cycle Tb22 that are adjacent mutually are both set at V2.

The values at the boundary of the pulse in the pulse cycle Ta1 and the pulse in the pulse cycle Ta21 that are adjacent mutually are both set at V1. The values at the boundary of the pulse in the pulse cycle Ta22 and the pulse in the pulse cycle Ta3 that are adjacent mutually are both set at V1. The values at the boundary of the pulse in the pulse cycle Tb1 and the pulse in the pulse cycle Tb21 that are adjacent mutually are both set at V1. The values at the boundary of the pulse in the pulse cycle Tb22 and the pulse in the pulse cycle Tb3 that are adjacent mutually are both set at V1. The value V1 is an exemplary first value and the value V2 is an exemplary second value.

Thus, even in a case where any pulses are selected from the pulses of the drive waveforms ComA and ComB, the values of the pulses at each boundary are identical. Thus, it is possible to prevent generation of a step (difference in a drive voltage) in the waveform of a drive voltage VCom generated by combining the pulses from the drive waveforms ComA and ComB.

As a result, a deterioration can be inhibited in the accuracy of the discharge amount of a liquid droplet to be discharged from a nozzle, so that a liquid droplet can be prevented from being discharged wrongly. Note that, in the waveform of the drive voltage VCom, the voltage value corresponding to the value V1 is an exemplary first voltage value and the voltage value corresponding to the value V2 is an exemplary second voltage value. The voltage value corresponding to the value V1 corresponds to the criterion value of drive voltage of a piezoelectric element 105 and is also referred to as intermediate potential.

As described above, the present embodiment enables acquisition of an effect similar to the effect of each embodiment described above. For example, coincidence between the pulse cycles Ta1 and Tb1 with coincidence in the generation timing of a pulse enables an increase in the number of representable gradations. Exclusion of at least the pulses in the pulse cycles Ta1 and Tb1 or the pulses in the pulse cycles Ta3 and Tb3 in the drive waveforms ComA and ComB from pulses for use in generation of a drive voltage VCom enables a higher drive frequency of the piezoelectric element 105. This leads to a shorter print cycle T, so that an increase can be made in the number of pixels printable per unit of time.

Furthermore, the present embodiment enables division of a pulse in each of the drive waveforms ComA and ComB into multiple pulses and free selection of the divided pulses. Thus, a further increase can be made in the number of representable gradations.

In each of the drive waveforms ComA and ComB, the values at the boundary of the divided pulses are set as V2. Thus, even in a case where any divided pulses are selected, the waveform of a drive voltage VCom to be generated due to combination of pulses from the drive waveforms ComA and ComB can be inhibited from being discrete. As a result, a deterioration can be inhibited in the accuracy of the discharge amount of a liquid droplet to be discharged from a nozzle, so that a liquid droplet can be prevented from being discharged wrongly.

[Aspect 1]

A liquid discharge device (22) includes: a piezoelectric element (105) to which a drive voltage is applied; a nozzle (123) from which a liquid is to be discharged in accordance with a change of the drive voltage; and circuitry (110) configured to: generate: a first drive waveform (ComA) including first multiple pulses switchable at first switch timings; and a second drive waveform (ComB) including second multiple pulses different from the first multiple pulses switchable at second switch timings, at least one the first switch timings of the first multiple pulses of the first drive waveform (ComA) and at least one of the second switch timings of the second multiple pulses of the second drive waveform (ComB) are the same; select first selected pulses from the first multiple pulses in the first drive waveform (ComA); and select second selected pulses from the second multiple pulses in the second drive waveform (ComB), and the second selected pulses do not overlap with the first selected pulses; couple the first selected pulses and the second selected pulses to generate the drive voltage.

[Aspect 2]

In the liquid discharge device (22) according to Aspect 1, the first multiple pulses have a different waveform with the second multiple pulses.

[Aspect 3]

In the liquid discharge device (22) according to Aspect 1, at least one of the first multiple pulses and the second multiple pulses includes a minute vibration pulse that vibrates a liquid surface of the liquid in the nozzle without causing the liquid to be discharged from the nozzle.

[Aspect 4]

In the liquid discharge device (22) according to Aspect 1, a number of pulses in the first multiple pulses is different from a number of pulses in the second multiple pulses.

[Aspect 5]

In the liquid discharge device (22) according to Aspect 1, the circuitry (110) sets: a first boundary voltage of two of the first multiple pulses adjacent at one of the first switching timings to one of a first value (V1) or a second value (V2); and a second boundary voltage of two of the second multiple pulses adjacent at one of the second switching timings to one of the first value (V1) or the second value (V2); the first boundary voltage is the same as the second boundary voltage when said one of the first switching timings and said one of the second switching timings are the same.

[Aspect 6]

In the liquid discharge device (22) according to Aspect 1, the circuitry (110) does not select at least one of a top pulse or a last pulse in the first multiple pulses and the second multiple pulses to generate the drive voltage.

[Aspect 7]

A liquid discharge apparatus (1) includes the liquid discharge device (22) according to Aspect 1.

Thus, the liquid discharge device can increase the number of applicable gradations while preventing a reduction in the number of combinations of selections of pulses used to generate a drive voltage.

The embodiments of the present disclosure have been described above. However, the present disclosure is not limited to the embodiments. Thus, modifications can be made without departing from the gist of the present disclosure and appropriate determinations can be made in accordance with application modes.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments such as the head drive circuit board 110 including the control IC 111 and the drive waveform generators 112A and 112B may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A liquid discharge device comprising:
a piezoelectric element to which a drive voltage is applied;
a nozzle from which a liquid is to be discharged in accordance with a change of the drive voltage; and
circuitry configured to:
generate:
a first drive waveform including first multiple pulses switchable at first switch timings; and
a second drive waveform including second multiple pulses different from the first multiple pulses switchable at second switch timings,
at least one the first switch timings of the first multiple pulses of the first drive waveform and at least one of the second switch timings of the second multiple pulses of the second drive waveform are the same;
select first selected pulses from the first multiple pulses in the first drive waveform; and
select second selected pulses from the second multiple pulses in the second drive waveform, and the second selected pulses do not overlap with the first selected pulses; and
couple the first selected pulses and the second selected pulses to generate the drive voltage.

2. The liquid discharge device according to claim 1, wherein
the first multiple pulses have a different waveform with the second multiple pulses.

3. The liquid discharge device according to claim 1, wherein
at least one of the first multiple pulses and the second multiple pulses includes a minute vibration pulse that vibrates a liquid surface of the liquid in the nozzle without causing the liquid to be discharged from the nozzle.

4. The liquid discharge device according to claim 1, wherein
a number of pulses in the first multiple pulses is different from a number of pulses in the second multiple pulses.

5. The liquid discharge device according to claim 1, wherein,
the circuitry sets:
a first boundary voltage of two of the first multiple pulses adjacent at one of the first switching timings to one of a first value or a second value; and
a second boundary voltage of two of the second multiple pulses adjacent at one of the second switching timings to one of the first value or the second value, and
the first boundary voltage is the same as the second boundary voltage when said one of the first switching timings and said one of the second switching timings are the same.

6. The liquid discharge device according to claim 1, wherein
the circuitry does not select at least one of a top pulse or a last pulse in the first multiple pulses and the second multiple pulses to generate the drive voltage.

7. A liquid discharge apparatus comprising the liquid discharge device according to claim 1.
